(19) United States
(12) Patent Application Publication
(10) Pub. No.: US 2009/0154149 A1
(43) Pub. Date: Jun. 18, 2009

(54) Inductive Flashlight Charging System with Concentric Coils

(76) Inventor: John HUANG, South San Francisco, CA (US)

Correspondence Address: GLENN PATENT GROUP, 3475 EDISON WAY, SUITE L, MENLO PARK, CA, 94025, US

(21) Appl. No.: 11/957,267

(22) Filed: Dec. 14, 2007

(51) Int. Cl. F21L 4/08; H02J 7/00

(52) U.S. Cl. 362/183; 320/108

(57) ABSTRACT

A rechargeable flashlight uses induction for charging, and thus does not utilize external contacts. The flashlight is cylindrically shaped, and has a secondary coil wrapped around a portion of the cylindrical body. The flashlight is placed within a ring shaped charger with a primary coil, such that the primary coil is wrapped around the secondary coil. This greatly maximizes the amount of interfacing area between the two coils, without adversely affecting the reflector design. This allows for the charging of a high powered flashlight, without requiring the flashlight to have a disadvantageously sized or constructed head. Furthermore, the primary coil of the charger can advantageously serve as a mechanical support for the flashlight.

### TECHNICAL FIELD

This invention pertains generally to flashlight technology, and more specifically to an improved inductive flashlight charging system.

### BACKGROUND ART

A flashlight is an essential tool for law enforcement officers. As part of an officer's duty gear, a flashlight provides an illumination source that can be critical during night shifts or when entering buildings and other potentially dark spaces. A rechargeable flashlight is preferred over a non-rechargeable flashlight for law enforcement applications, as an officer's flashlight is typically used on a daily basis. A rechargeable flashlight can be fully charged at the beginning of a duty shift. As the law enforcement officer is gearing up, the flashlight is “topped off” and ready for use when the officer goes on duty.

Most rechargeable flashlights require a separate charging unit. The charging unit can be a receptacle for the flashlight, such that when the flashlight is placed in the receptacle, the internal battery of the flashlight is provided with electricity. Current charger design often involves the application of a pair of arms which mechanically move to grab and hold the flashlight in position, and then align the electrical contact points on the flashlight with the electrical contact points on the charger. The direct alignment of the contact establishes electrical conduction, through which the battery is recharged with the electricity provided by the charger.

Placing the flashlight in the charging unit requires the proper alignment of the electrical contacts between the flashlight and the charger. The tight holding of the grabbing arms often cause difficulties in manipulating the flashlight to make the proper alignment. Since the contacts are usually under the flashlight and hidden from the view, the mating of the contacts often requires repeated attempts and a great deal of adjustment. This nuisance prolongs the charger attachment process and often frustrates the user. It is desirable to law enforcement officers for the process of attaching and detaching the flashlight to and from the charging unit to be as easy as possible, especially since such charging occurs at the beginning and at the end of a shift.

Since the electrical conduction between the flashlight and the charging unit requires positive connection of both units, metallic contacts are usually used on the charger for matching metallic contacts on the flashlight. Most designs rely on a pair of metallic contacts for completing an electrical loop, one contact each for the positive and the negative polarity. A flashlight with exposed contacts on its external surface poses several disadvantages.

Most flashlights are shaped as cylindrical tubes. A flashlight typically houses a battery, attaches a light source with reflector to the top of the cylinder, and is further designed to fit to the ergonomic form factor of the human hand. The introduction of electrical contacts increases the engineering design challenge. The challenge is usually on the placement and the securing of the electrical contacts on the flashlight body. A fine balance between the mechanical integrity and complexity of the design and the electrical contact placement is often needed.

Furthermore, the mechanical design for placing the electrical contacts requires a certain level of water resistance to ensure adequate waterproofing construction. The design also needs to be able to withstand the frequent mating of the metallic contacts of the flashlight with those of the charger, as well as the wear-and-tear of being a piece of frequently-used duty gear. Despite much effort towards improving the contact design, since the contacts are externally placed, the electrical contacts deteriorate over the lifespan of the flashlight. This causes increasing poor contact mating over time, and thus reduced electrical conduct efficiency.

Placing metallic contacts externally where the contacts are connected to the internal battery can potentially pose a serious electrical hazard to the user. Although certain safety precautions may be taken through the introduction of diodes to prevent reverse electrical flow, unexpected mechanical failure can potentially cause internal battery explosion or create external electrical sparks that can cause external explosion. These risks are derived from having external electrical contacts on a hand held device.

Given these disadvantages of using electrical contacts on a flashlight, it is desirable to the manufacturers of rechargeable flashlights and law enforcement officers to completely eliminate electrical contacts from flashlight design.

In some designs, the process of charging through electrical contact conduction is replaced by induction charging. Inductive charging uses electromagnetic induction, whereby the charger induces a current inside the flashlight, which transfers the electrical power to the batteries. An induction coil in the charger creates an alternating electromagnetic field, and a second induction coil in the flashlight takes power from the electromagnetic field and converts it back into electrical current to charge the battery. Essentially, two induction coils in close proximity combine to form an electrical transformer.

An inductive flashlight charging system is disclosed in United States Patent Application number 2007/0127184 A1 (“Wong”). In Wong, the surface of the primary coil takes on the shape of a flat surface as part of a charging platform, onto which a flashlight can be placed such that its head rests on the surface of the platform. The secondary coil is placed in the head of the flashlight, such that it faces down on the surface of the charging platform. As noted above, most flashlights have a cylindrical shape. Placing a cylindrically shaped flashlight with the secondary coil in the head on a flat surface in which the primary coil is located results in a minimal amount of interfacing area between the two coils, as the majority of the coil portions are far away from each other. In other words, in Wong the charger is a flat surface, while the front of the flashlight is another surface. Visually, this equates to having two surfaces facing each other. Although this design minimizes the distance between the coils, the disadvantage is that the area around the head of the flashlight toward the front is usually taken up by the reflector. This geometric restriction reduces the area of interfacing which is not desirable for induction charging. However, if the reflector diameter is reduced to provide space for the coil, it will diminish the focused intensity of the light.

What is needed is a flashlight charging system without the disadvantages of existing systems described above.

### SUMMARY

A rechargeable flashlight uses induction for charging, and thus does not utilize external contacts. The flashlight is cylindrically shaped, and has a secondary coil wrapped around a portion of the cylindrical body. The flashlight is placed within a ring shaped charger with a primary coil, such that the primary coil is wrapped around the secondary coil. This greatly maximizes the amount of interfacing area between the two coils, without adversely affecting the reflector design. This allows for the charging of a high powered flashlight, without requiring the flashlight to have a disadvantageously sized or constructed head. Furthermore, the primary coil of the charger can advantageously serve as a mechanical support for the flashlight.

The features and advantages described in this summary and in the following detailed description are not all-inclusive, and particularly, many additional features and advantages will be apparent to one of ordinary skill in the relevant art in view of the drawings, specification, and claims hereof. Moreover, it should be noted that the language used in the specification has been principally selected for readability and instructional purposes, and may not have been selected to delineate or circumscribe the inventive subject matter, resort to the claims being necessary to determine such inventive subject matter.

### BRIEF DESCRIPTION OF THE DRAWINGS

FIG. 1 illustrates a flashlight with an internal secondary induction coil and no exposed contact points, according to one embodiment of the present invention.

FIG. 2 illustrates the positioning of an internal secondary induction coil within a flashlight, according to one embodiment of the present invention.

FIG. 3 illustrates a charger with a primary induction coil positioned for charging a flashlight with an internal secondary induction coil, according to one embodiment of the present invention.

FIG. 4 illustrates a flashlight with an internal secondary induction coil placed inside a charger with a primary induction coil, according to one embodiment of the present invention.

FIG. 5 illustrates a flashlight with an internal secondary induction coil and a geometric key, according to one embodiment of the present invention.

FIG. 6 illustrates a flashlight with an internal secondary induction coil and a geometric key placed inside a charger with a primary induction coil and a concave geometric shape, according to one embodiment of the present invention.

FIG. 7 illustrates a correspondence between the geometric key of a flashlight and the concave geometric shape of a charger, according to one embodiment of the present invention.

FIG. 8 illustrates a flashlight with an internal secondary induction coil placed inside a charger with a primary induction coil, according to another embodiment of the present invention.

The Figures depict embodiments of the present invention for purposes of illustration only. One skilled in the art will readily recognize from the following discussion that alternative embodiments of the structures and methods illustrated herein may be employed without departing from the principles of the invention described herein

### DETAILED DESCRIPTION

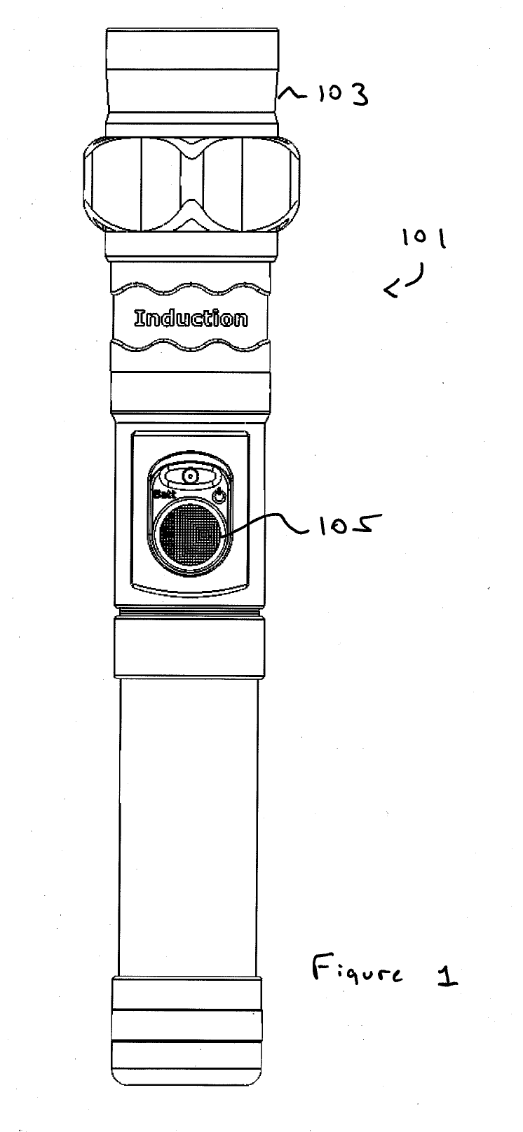

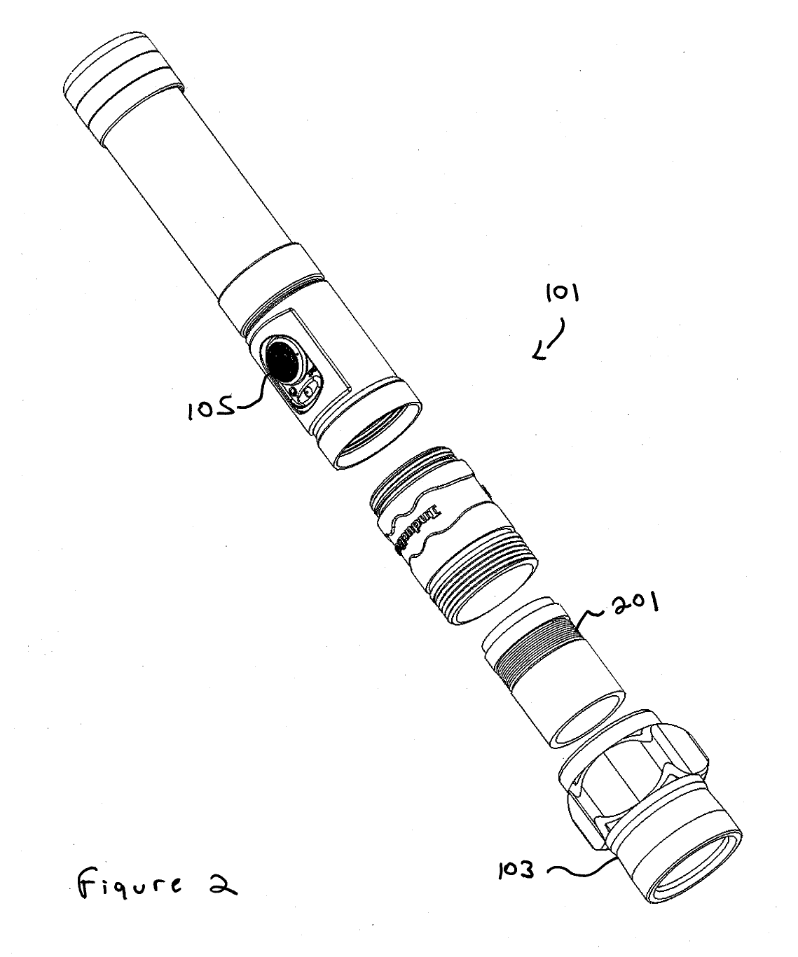

FIG. 1 illustrates a flashlight 101 that can be charged with induction, which does not require any contact points on the flashlight 101 or the charger 301, and thus does not have any contact points exposed, according to one embodiment of the present invention. The section below the head 103 and above the switch 105 contains the secondary coil 201 for charging. In FIG. 2, the secondary coil 201 in the flashlight 101 is shown. As illustrated in FIG. 2, the secondary coil 201 is positioned in a circumference around the body of the flashlight 101.

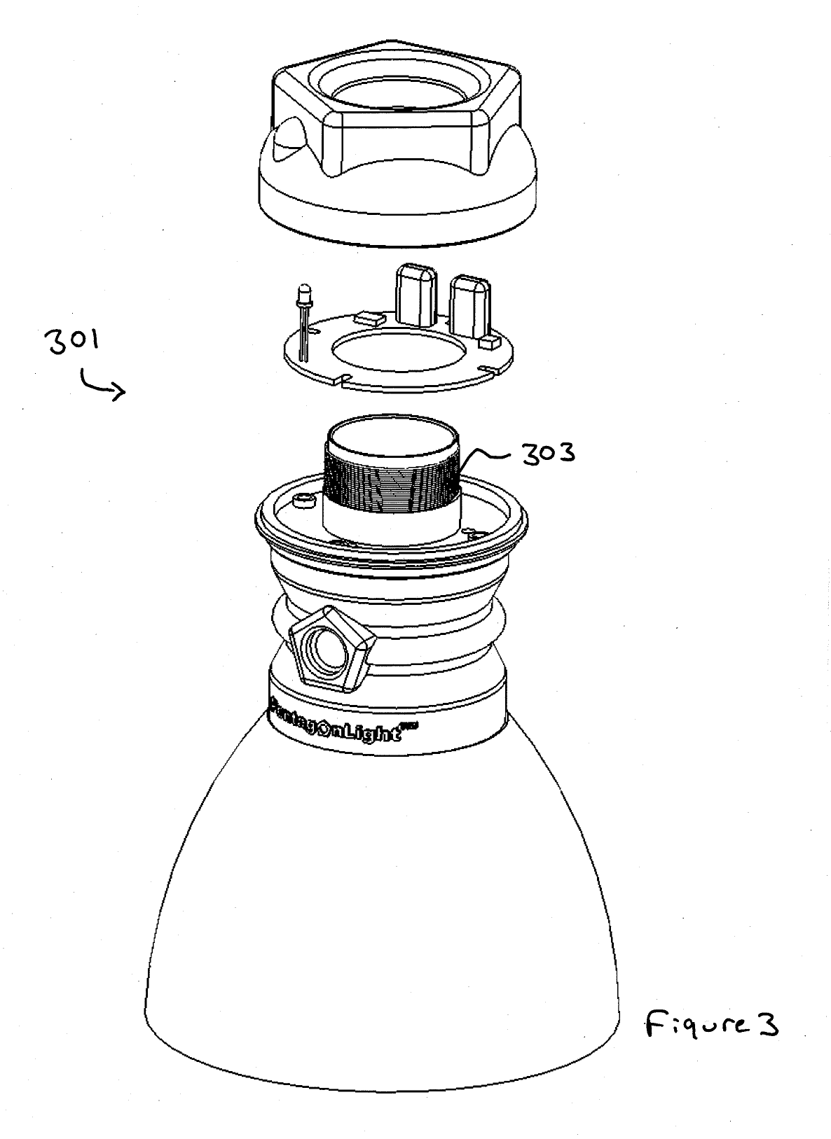

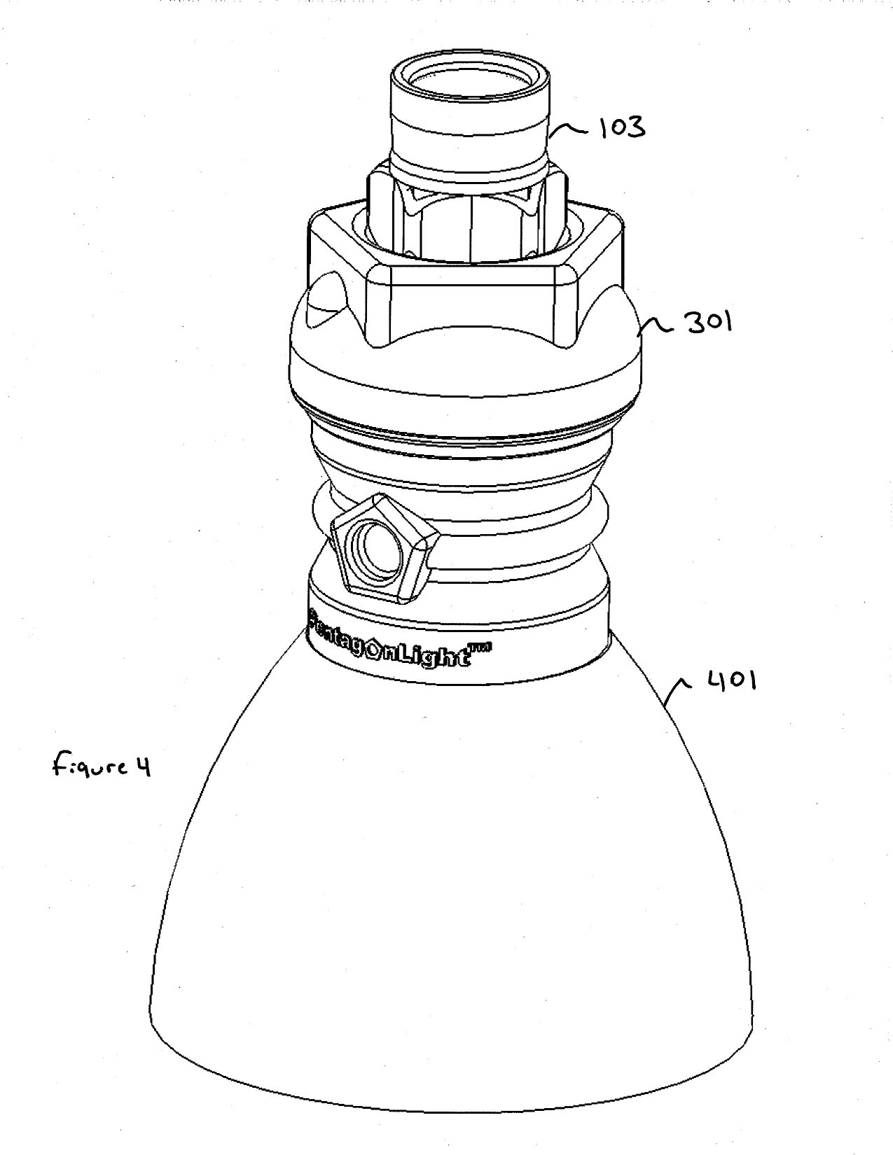

FIG. 3 illustrates a corresponding charger 301, according to one embodiment of the present invention. As illustrated, the primary coil 303 is positioned in the charger 301 for charging the flashlight 101. FIG. 4 illustrates the flashlight 101 placed inside the charging system, according to one embodiment of the present invention. The flashlight 101 is inserted from the top into the charger 301. When the flashlight 101 is placed in the charger 301, the primary coil 303 of the charger 301 is positioned radially in a plane that is wrapped around the body of the flashlight 101 such that the two coils 201, 303 are proximate, and induction occurs. The flashlight 101 takes power from the electromagnetic field and converts it back into electrical current to charge the battery inside the flashlight 101 (not illustrated). Essentially, the two induction coils 201, 303 in close proximity combine to form an electrical transformer.

As explained above, two induction coils 201, 303, one inside the flashlight 101 and the other in the charger 301 will serve to transmit power in charging the battery within the flashlight 101. As illustrated in FIG. 4, the charger 301 is mounted to a stand 401, which positions the charger 301 at an appropriate height for charging the flashlight 101. More specifically, the charger 301 and stand 401 combine to form an apparatus for placing the coil 201 with smaller circumference, which is inside the flashlight 101, within the coil 303 with larger circumference, which is part of the charger 301. This arrangement is shown in FIG. 4. Since charging radially does not require registration in the plane of charging, the user will not need to make any alignments when placing the flashlight 101 inside the charger 301. Geometrically, the primary charger coil 303 surrounds the secondary coil 201 inside the flashlight 101, along the central axis of the flashlight 101. Visually, this equates to rolling up two planes. The plane inside is the secondary coil 201 within the flashlight 101 while the plane wrapping around the inner plane is the primary coil 303 within the charger 301. This maximizes the induction surface around a circumference.

The area of induction between two surfaces is exponentially proportional to the amount of current that can be delivered from the primary coil 303 to the secondary coil 201. Increasing the area of induction improves the amount of current deliverable to the flashlight 101. Newer rechargeable flashlights 101 introduced in the market today, especially those designed for law enforcement officers, utilize lithium-ion and other high capacity batteries. The large area of induction provided according to the illustrated embodiment of present invention enables the recharging of such high capacity batteries. Increasing the rate of current deliverable reduces the amount of time needed for such recharging. Having two surfaces wrapped around each other as per the illustrated embodiment of the present invention maximizes the induction surface around a circumference of a cylindrical body.

Another physical parameter that greatly affects the efficiency of induction charging is the distance between the primary coil 303 and the secondary coil 201. As the distance increases, the influence of the electromagnetic field reduces exponentially, thereby diminishing the strength of possible electrical induction. Since induction is optimized with the minimal space between the primary 303 and the secondary coil 201, placing the two coils 201, 303 in proximity around a circumference increases the area of induction without increasing the distance between the two coils 201, 303.

Another advantage of having the primary coil 303 wrap around the secondary coil 201 is that the construction of the primary coil 303 can provide mechanical support for the flashlight 101. By inserting the cylindrically shaped flashlight 101 through the primary coil 303, the primary coil 303 can act as a stopper. The stopper forces the positioning of the secondary coil 201 to within the plane of the primary coil 303. By registering the plane, any additional user attendance needed to ensure proper alignment for induction is minimized.

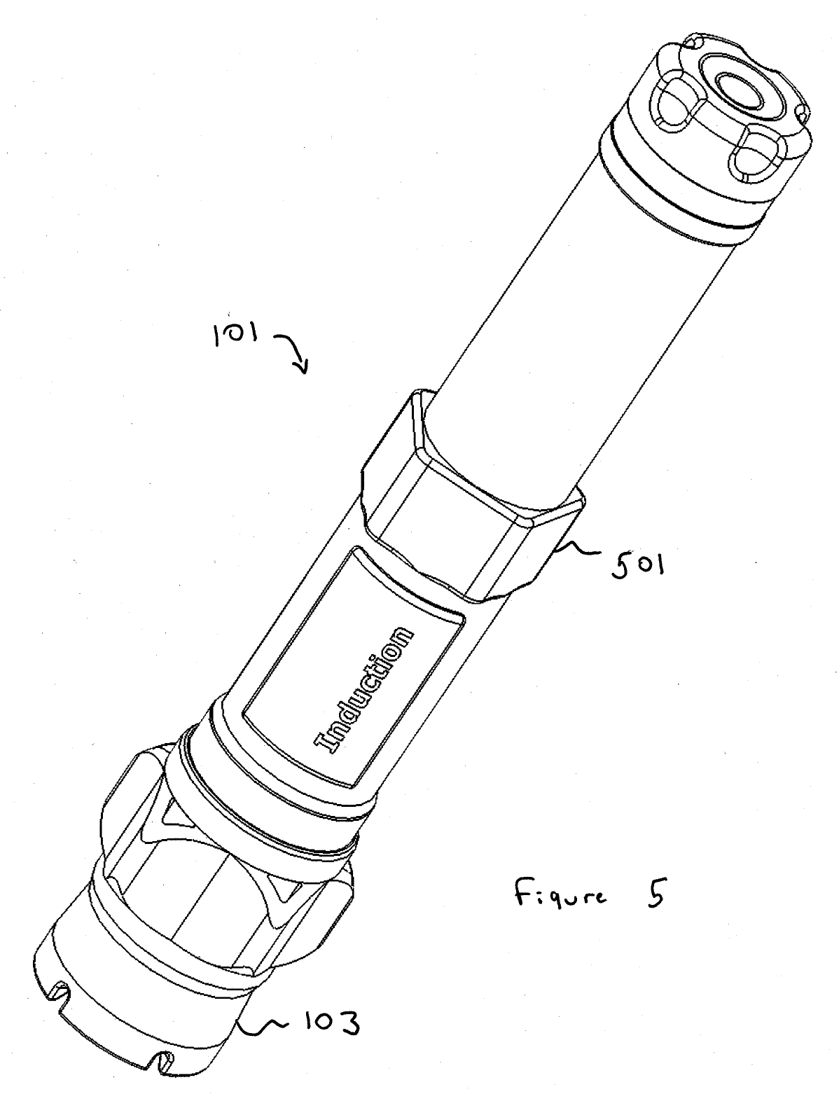

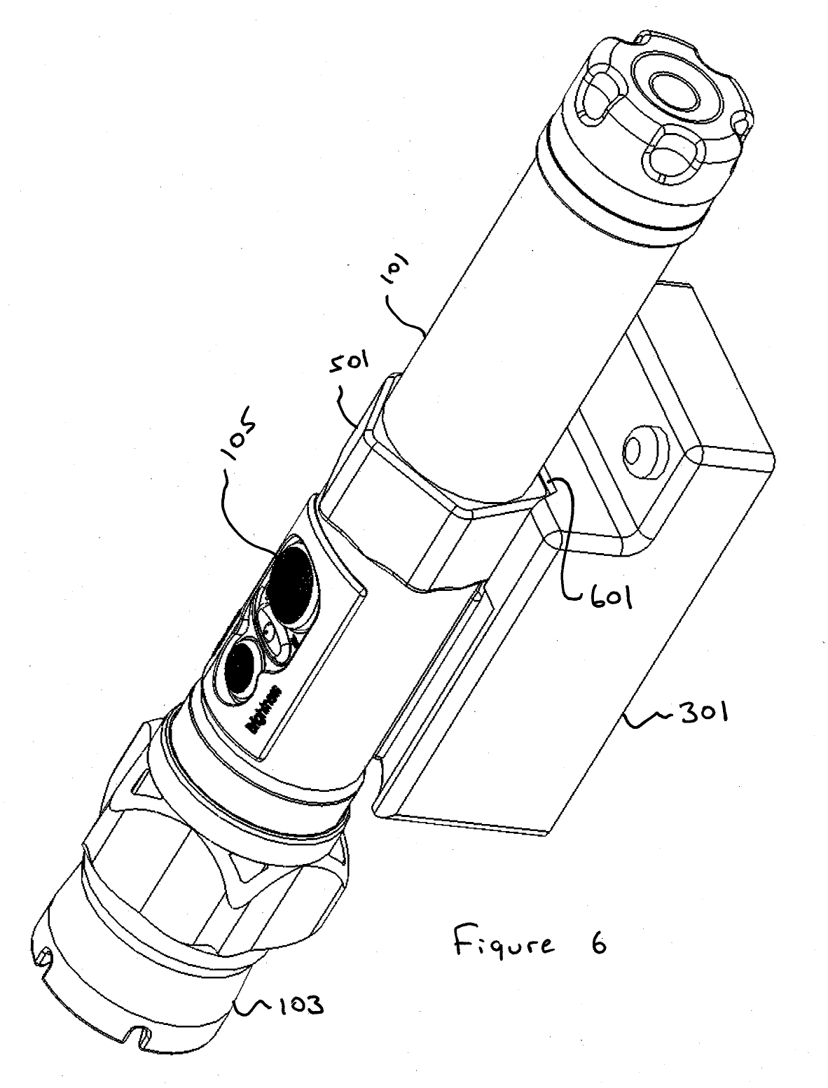

FIG. 5 illustrates a flashlight 101 according to another embodiment of the present invention, in which the flashlight 101 is fitted with a geometric key 501 to provide optimal registration of the plains of the coils 201, 303 when the flashlight is placed into a corresponding charger 301. As with the flashlight 101 illustrated in FIG. 1, the flashlight 101 of this embodiment has a secondary coil 201 positioned around part of the circumference of the body. Turning to FIG. 6, the primary coil 303 is positioned inside the corresponding charger 301, which has a concave geometric shape 601 to accommodate the geometric key 501 of the flashlight 101. When placing the flashlight 101 on the charger 301 as shown in FIG. 6, the two coils 201, 303 are proximate to each other, such that charging can initiate.

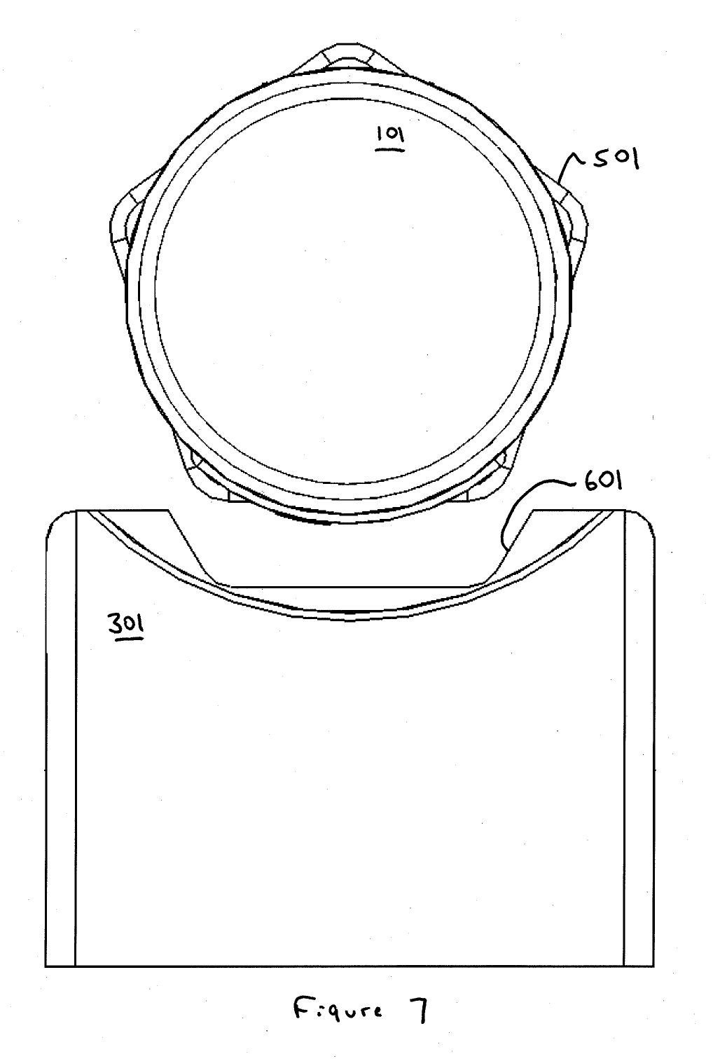

Whenever the planes of two concentric coils 201, 303 are proximate to each other, some level of induction charging can take place. However, the interfacing between the planes is increased when the two planes are registered to each other. The efficiency and the charging capacity are maximized when this registration is optimal. In this embodiment, the matching geometric shape 601 of the charger 301 accepts the flashlight 101 with the corresponding geometric key 501 in a particular orientation. The matching key 501 and concave shape 601 guide the flashlight 101 into the charger 301 so as to facilitate the registration of the two planes to ensure optimal interfacing of the coils 201, 303. FIG. 7 illustrates the correspondence between the geometric shape 601 of the charger 301 and the corresponding geometric key 501 of the flashlight 101.

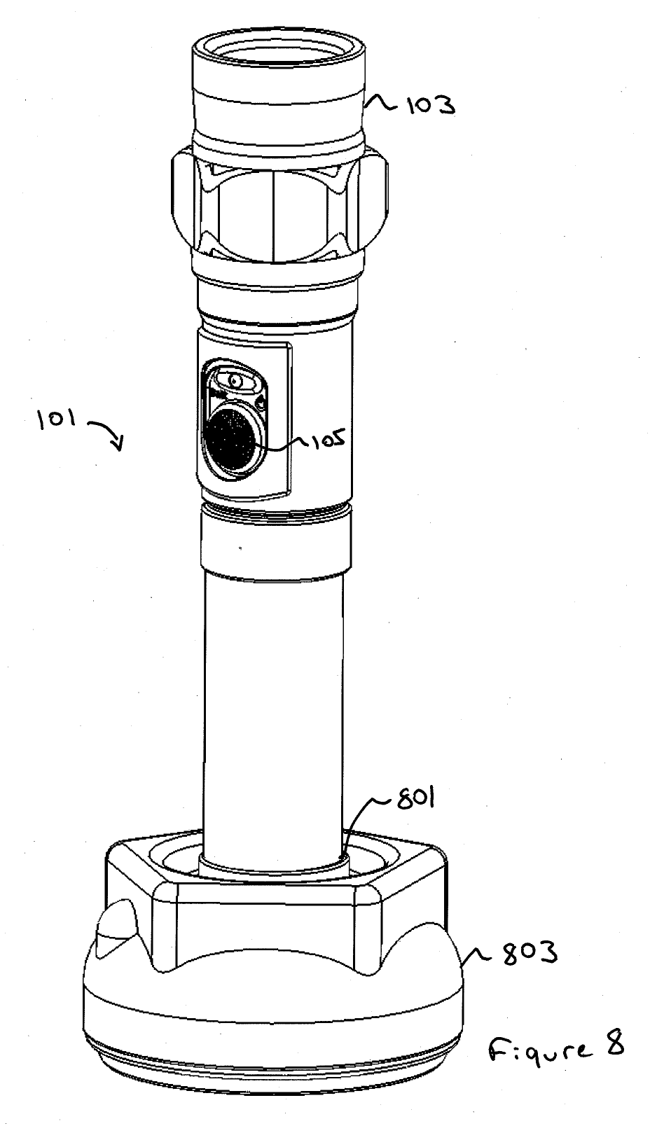

FIG. 8 illustrates another embodiment of the present invention according to which a flashlight 101 with a secondary coil 201 positioned around the circumference of the tail 801 is inserted into a holder 803, such that the holder 803 charges the flashlight 101 through the circumference of the tail cap 801. This embodiment involves placing the flashlight 101 inside the holder 803 as shown in FIG. 8. The holder 803 may serve as a guide for positioning the primary coil 303 and the secondary coil 201 in position for induction charging. In one embodiment, the coils 201, 303 are positioned radially along the axis of the flashlight 101 as described above. In another embodiment, the secondary coil 201 may be positioned at the base of the tail cap 801 in a flattened position, with the primary coil 303 positioned directly under the tail cap 801 in the bottom of the holder 803. In this embodiment, the holder 803 charges the flashlight 101 through the bottom of the tail cap 801. Although this reduces the area of charging as compared to the embodiment described above, the holder 803 still provides registration for positioning the two coils 201, 303 in proximity for a maximal charging efficiency.

The embodiments of the present invention provide a great improvement in flashlight 101 charging technology for law enforcement. The use of induction charging eliminates the need for having electrical contacts externally on the flashlight 101. A rechargeable flashlight 101 without external contacts benefits the law enforcement officer, as it eliminates the disadvantages associated with external contacts, as discussed above. The attaching and detaching of the flashlight 101 to the charger 301 becomes easier as the mechanical arms are not needed to tightly secure the flashlight 101 to ensure proper mating and the alignment of the electrical contacts. Having the primary coil 303 wrapped around the secondary coil 201 greatly maximizes the amount of interfacing area between the two coils 201, 303, without adversely affecting the reflector design. This allows for the charging of a high powered flashlight 101, without requiring the flashlight 101 to have a disadvantageously sized or constructed head 103. Furthermore, the primary coil 303 of the charger 301 can advantageously serve as a mechanical support for the flashlight 101.

As will be understood by those familiar with the art, the invention may be embodied in other specific forms without departing from the spirit or essential characteristics thereof. Likewise, the particular naming and division of the members, features, attributes and other aspects are not mandatory or significant, and the mechanisms that implement the invention or its features may have different names, divisions and/or formats. Accordingly, the disclosure of the present invention is intended to be illustrative, but not limiting, of the scope of the invention, which is set forth in the following claims.

What is claimed is:

1. A flashlight with a rechargeable battery, the flashlight comprising the following components:
a substantially cylindrically shaped body comprising a head end and a tail end; and
a secondary induction coil positioned in a circumference around a portion of the substantially cylindrically shaped body;
wherein said secondary induction coil is adapted to be placed within a larger primary coil of a charging apparatus, such that such that the secondary coil and the primary coil are proximate, resulting in induction for charging the battery.

2. The flashlight of claim 1 wherein:
the secondary coil is positioned in a circumference around at least a portion of the head end of the substantially cylindrically shaped body.

3. The flashlight of claim 1 wherein:
the secondary coil is positioned in a circumference around at least a portion of the tail end of the substantially cylindrically shaped body.

4. The flashlight of claim 1 wherein:
the rechargeable battery further comprises a lithium-ion battery.

5. The flashlight of claim 1 further comprising:
a geometric shape positioned in a circumference around a portion of the substantially cylindrically shaped body, said geometric shape being adapted to guide the placement of the flashlight into a charging apparatus with a concave geometric shape, said charging apparatus containing a primary coil, such that a plane formed by the secondary coil and a plane formed by the primary coil are registered, resulting in induction for charging the battery.

6. The flashlight of claim 5 wherein:
the geometric shape is substantially pentagonal.

7. An apparatus for charging a flashlight with a rechargeable battery, the charging apparatus comprising the following components:
a substantially ring shaped charging member; and
a primary induction coil positioned within the substantially ring shaped member to form a circumference;
wherein said primary induction coil is adapted to form a plane that is wrapped around a smaller secondary coil of a flashlight placed within the charging member, such that the secondary coil and the primary coil are proximate, resulting in induction for charging the battery.

8. The apparatus of claim 7 further comprising:
a stand coupled to the substantially ring shaped charging member, such that the charging member is elevated at a height relative to a surface on which the stand is placed;
wherein the height is such that the secondary coil of the flashlight placed within the charging member and the primary coil are proximate.

9. The apparatus of claim 7 wherein:
the primary coil is adapted to provide mechanical support for the flashlight, such that the primary coil acts as a stopper to the flashlight, positioning the secondary coil of the flashlight within the plane of the primary coil.

10. A rechargeable flashlight system comprising the following components:
a flashlight with a rechargeable battery, a substantially cylindrically shaped body comprising a head end and a tail end, and a secondary induction coil positioned in the tail end of the body; and
a holder with a primary coil, said holder being adapted to physically accommodate the flashlight such that the primary coil is positioned under the secondary induction coil of the flashlight;
wherein the holder is further adapted to position the flashlight such that the primary coil and the secondary coil are proximate, resulting in induction for charging the battery.
